(19) United States
(12) Patent Application Publication
(10) Pub. No.: US 2014/0224594 A1
(43) Pub. Date: Aug. 14, 2014

(54) ELEVATOR BRAKING SYSTEM

(71) Applicant: OTIS ELEVATOR COMPANY, Farmington, CT (US)

(72) Inventors: Justin Billard, Amston, CT (US); Zbigniew Piech, Cheshire, CT (US)

(73) Assignee: OTIS ELEVATOR COMPANY, Farmington, CT (US)

(21) Appl. No.: 14/349,734

(22) PCT Filed: Oct. 7, 2011
(86) PCT No.: PCT/US2011/055222

§ 371 Date: Apr. 4, 2014

(51) Int. Cl. B66B 5/18

(52) U.S. Cl. CPC B66B 5/18
USPC 187/359

(57) ABSTRACT

A braking system for an elevator system includes two or more braking surfaces located at an elevator car and frictionally engageable with a rail of an elevator system. One or more actuators are located at the elevator car and are operably connected to at least one braking surface of the two or more braking surfaces. The one or more actuators are configured to urge engagement and/or disengagement of the at least one braking surface with the rail to stop and/or hold the elevator car during operation of the elevator system. One or more braking guides are located at the elevator car to maintain a selected distance between the two or more braking surfaces and the rail.

### BACKGROUND OF THE INVENTION

The subject matter disclosed herein relates to elevator systems. More specifically, the subject disclosure relates to braking systems for elevators.

Traction elevator systems are driven by a motor having a traction sheave, referred to as a machine, which drives a lifting means, typically ropes or belts, attached to an elevator car. The speed and motion of the elevator car are controlled by a variety of devices scattered throughout the elevator system which are installed and adjusted individually. For example, a brake at the machine is used to hold the elevator car during normal operation and as a first response to stop and hold the elevator car during emergency operation. In addition, safety brakes are mounted on the elevator car are utilized as a redundant braking device to stop the car in the hoistway in the event of an emergency. Installation and setup of all of these separate devices is costly and time consuming.

### BRIEF DESCRIPTION OF THE INVENTION

According to one aspect of the invention, a braking system for an elevator system includes two or more braking surfaces located at an elevator car and frictionally engageable with a rail of an elevator system. One or more actuators are located at the elevator car and are operably connected to at least one braking surface of the two or more braking surfaces. The one or more actuators are configured to urge engagement and/or disengagement of the at least one braking surface with the rail to stop and/or hold the elevator car during operation of the elevator system. One or more braking guides are located at the elevator car to maintain a selected distance between the two or more braking surfaces and the rail.

Additionally or alternatively, the invention may include one or more of the following features, either individually or in various combinations: the one or more actuators including one or more electrical coils magnetically interactive with the at least one braking surfaces; the one or more electrical coils configured to urge the at least one braking surface away from the rail when energized; at least one biasing member to bias the at least one braking surface toward the rail; the at least one biasing member comprising a stack of disc springs; at least one support to connect the braking system to the elevator car; the braking system being slidably connected to the at least one support; and the at least one support at least partially formed of a compliant material.

According to another aspect of the invention, an elevator system includes one or more rails fixed in a hoistway and an elevator car configured to move through the hoistway along the one or more rails. One or more braking systems are secured to the elevator car and include two or more braking surfaces frictionally engageable with the one or more rails. One or more actuators are operably connected to at least one braking surface of the two or more braking surfaces. The one or more actuators are configured to urge engagement and/or disengagement of the at least one braking surface with the rail to stop and/or hold the elevator car during operation of the elevator system. One or more braking guides are located at the elevator car to maintain a selected distance between the two or more braking surfaces and the rail.

Alternatively in this or other aspects of the invention, the one or more braking systems is four braking systems.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic of an embodiment of an elevator system;

FIG. 2 is a perspective view of an embodiment of a braking system for an elevator;

FIG. 3 is a cross-sectional view of an embodiment of a braking system for an elevator;

FIG. 4 is another cross-sectional view of an embodiment of a braking system for an elevator;

FIG. 5 is a perspective view of another embodiment of a braking system for an elevator;

FIG. 6 is a perspective view of yet another embodiment of a braking system for an elevator;

FIG. 7 is a perspective view of still another embodiment of a braking system for an elevator;

FIG. 8a is a perspective view of another embodiment of a braking system for an elevator;

FIG. 8b is a perspective view of yet another embodiment of a braking system for an elevator; and

FIG. 9 is a cross-sectional view of another embodiment of a braking system for an elevator.

### DETAILED DESCRIPTION OF THE INVENTION

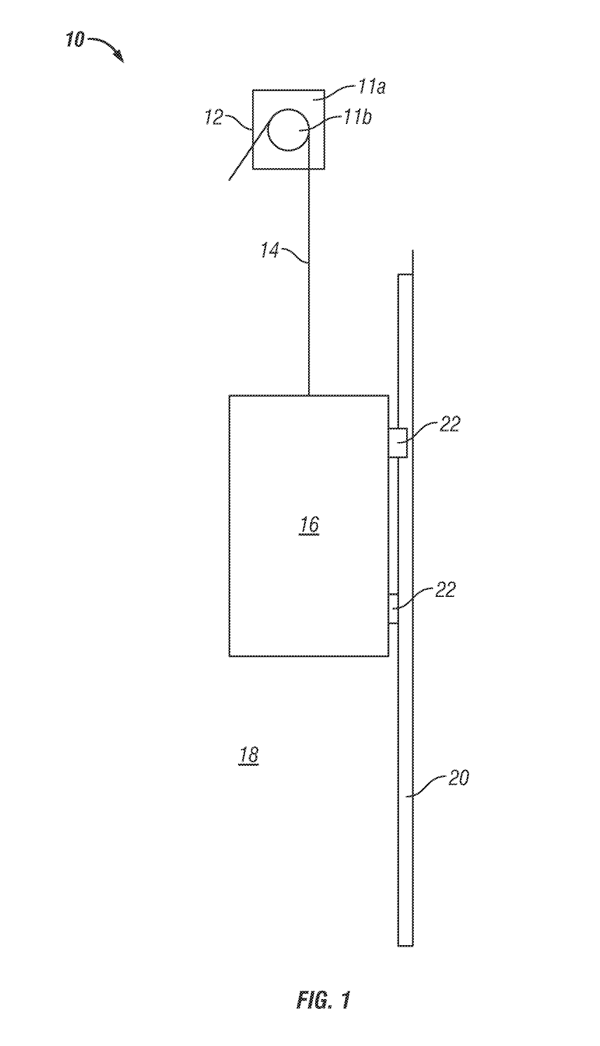

Shown in FIG. 1 is an embodiment of an elevator system 10. The elevator system 10 includes a motor 11a having a traction sheave 11b for driving the elevator system, known as a machine 12. The machine 12 drives a lifting means, for example, one or more belts or ropes, hereinafter referred to as “ropes” 14 over one or more pulleys to urge motion of an elevator car 16 up and/or down in a hoistway 18. One or more rails 20, typically at least two rails 20, are located in the hoistway 18 and the elevator car 16 is positioned in the hoistway 18 such that the rails 20 guide the motion of the elevator car 16. A braking system, generally shown at 22, is secured to the elevator car 16. The braking system 22 interacts with the rails 20 to hold the elevator car 16 during normal operation of the elevator 10, for example, stopping at a floor to load and/or unload passengers. Further, some embodiments of the braking system 22 include the function of a traditional emergency brake, or safety, to slow and/or stop movement of the elevator car 16 in the event of an emergency, for example, the elevator car 16 exceeding a predetermined speed,.

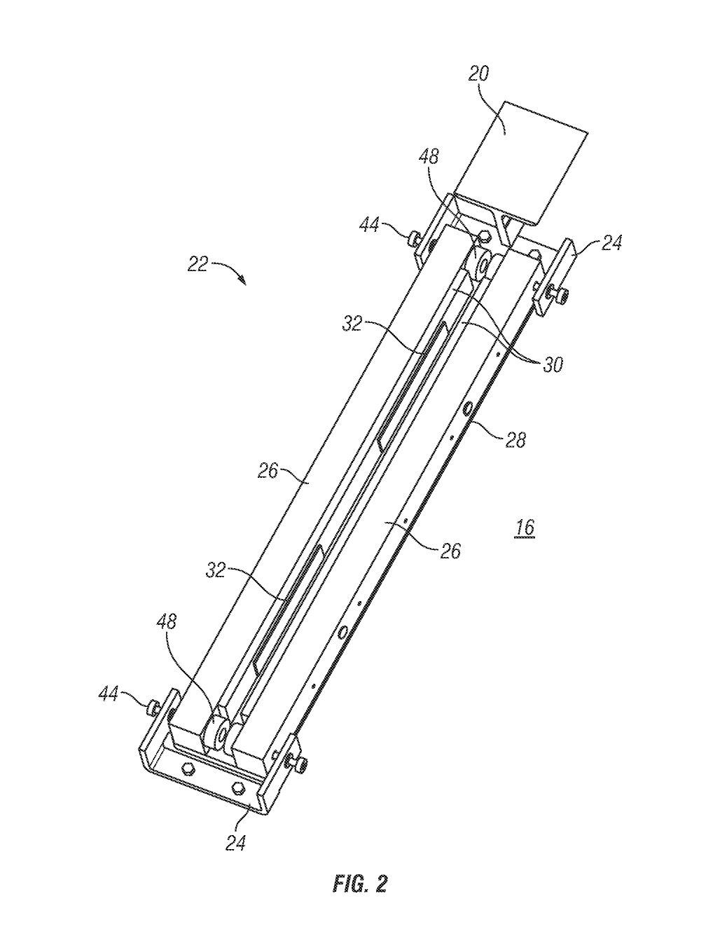

Referring to FIG. 2, shown is an embodiment of a braking system 22. The braking system 22 is secured to the elevator car 16 via, for example one or more supports 24 with the various components of the braking system 22 secured thereto. In the embodiment of FIG. 2, each support 24 is u-shaped, with a support 24 located at each end of the braking system 22. In some embodiments, four braking systems 22, are fixed to the elevator car 16, with two braking systems 22 at each of the two rails 20. The braking system 22 includes a backing block 26 located at each side of the rail 20. The backing blocks 26 are secured to a brake bracket 28. A braking plate 30 with a brake pad 32 affixed thereto is located between each backing block 26 and the rail 20. The braking plate 30 is articulable toward the rail 20 such that the brake pads 32 engage the rail 20 to slow, stop or hold the elevator car 16 via friction.

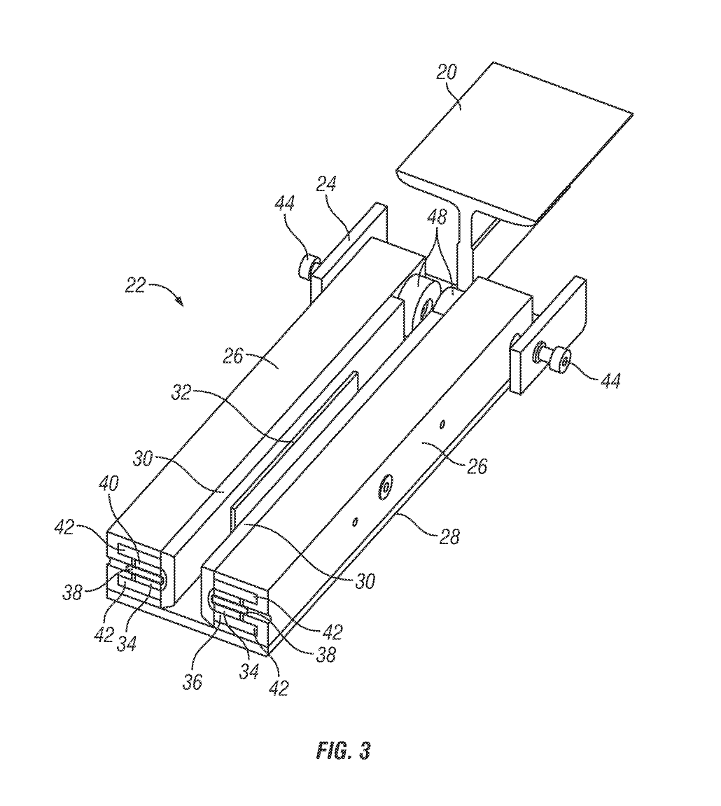

Referring to FIG. 3, the braking plate 30 and brake pads 32 are biased toward the rail 20 by a plurality of springs, for example one or more disc spring stacks 34. Each spring stack 34 is located in a spring pocket 36 in the backing block 26, and in some embodiments are arranged around a spring pin 38 which acts as a spring guide for the spring stack 34. Alternatively, a pocket wall 40 may act as the spring guide. One or more electrical coils 42 are located in the backing block 26. When energized, the electrical coils 42 generate a magnetic field to overcome the bias of the spring stacks 34 to draw the brake pads 32 away from the rail 20 to allow movement of the elevator car 16 along the rail 20. When it is desired to slow, stop or hold the elevator car 16, the electrical coils 42 are deenergized, thereby allowing the spring stacks 34 to urge the brake pads 32 into contact with the rail 20. The necessary braking force to slow, stop or hold the elevator car 12 is provided by spring force of the spring stacks 34 forcing the brake pads 32 into contact with the rail 20, and by frictional forces of the brake pad 32 on the rail 20.

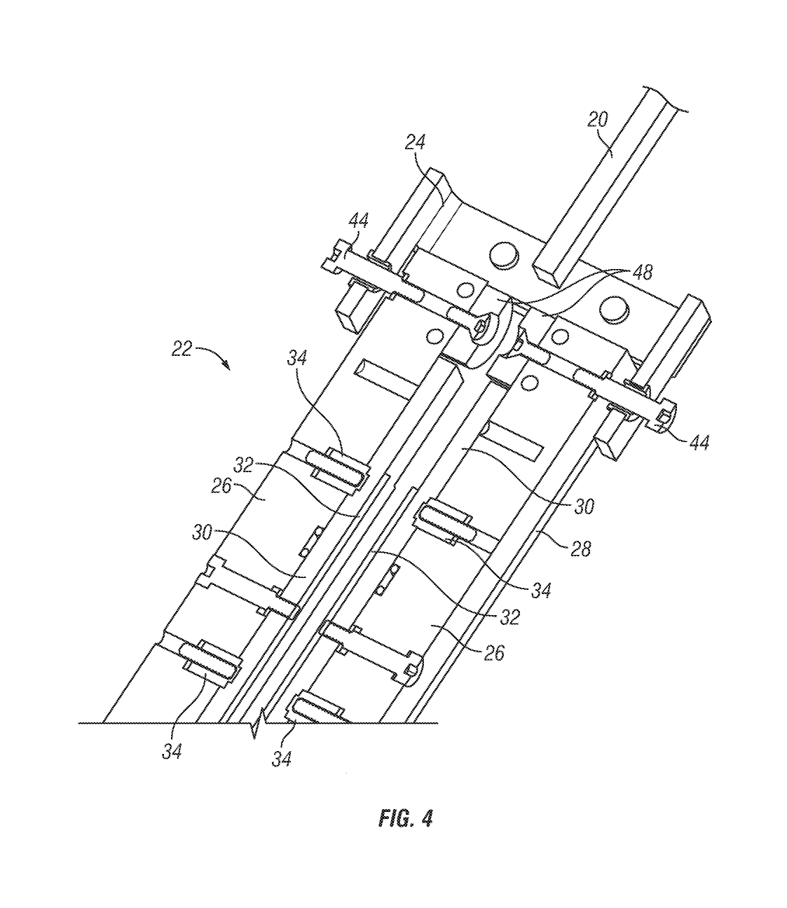

Referring to FIG. 4, the braking system 22 is secured to the supports 24 with side-to-side “play” to allow side-to-side movement of the braking system 22 relative to the supports 24. This allows the braking system 22 to follow any waves or other such changes in rail position along the length of the rail 20. In some embodiments, the play is achieved by mounting the braking system 22 to the supports 24 via one or more mounting pins 44 extending from the backing block 26 through the support 24. The mounting pins 44 may be slidably located at the supports 24 to allow the side to side movement of the braking system 22. It is to be appreciated, however, that the mounting scheme of FIG. 4 is merely exemplary.

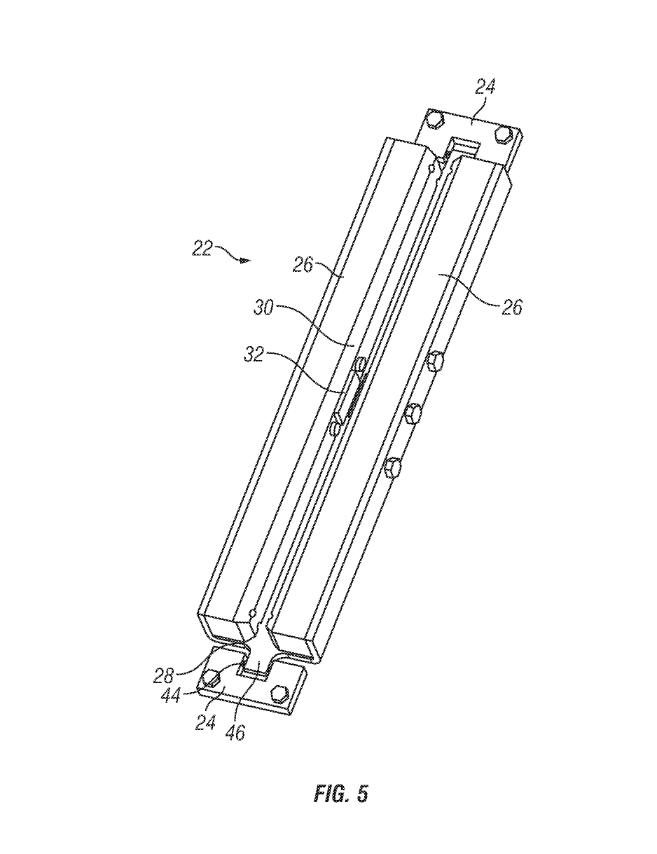

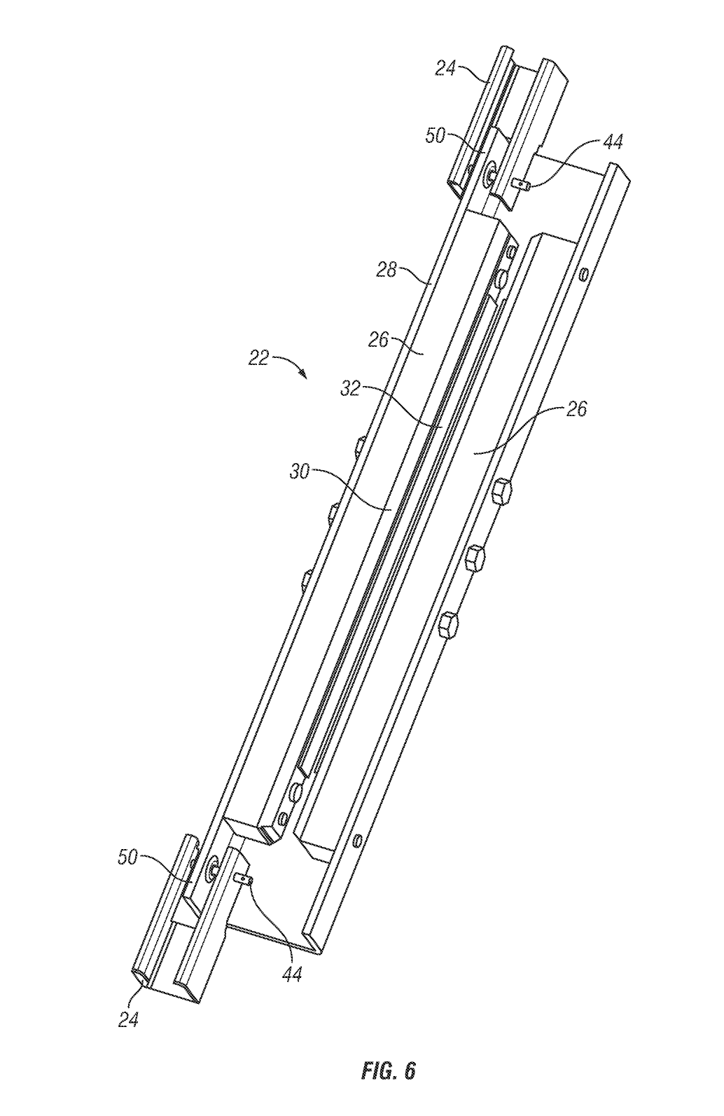

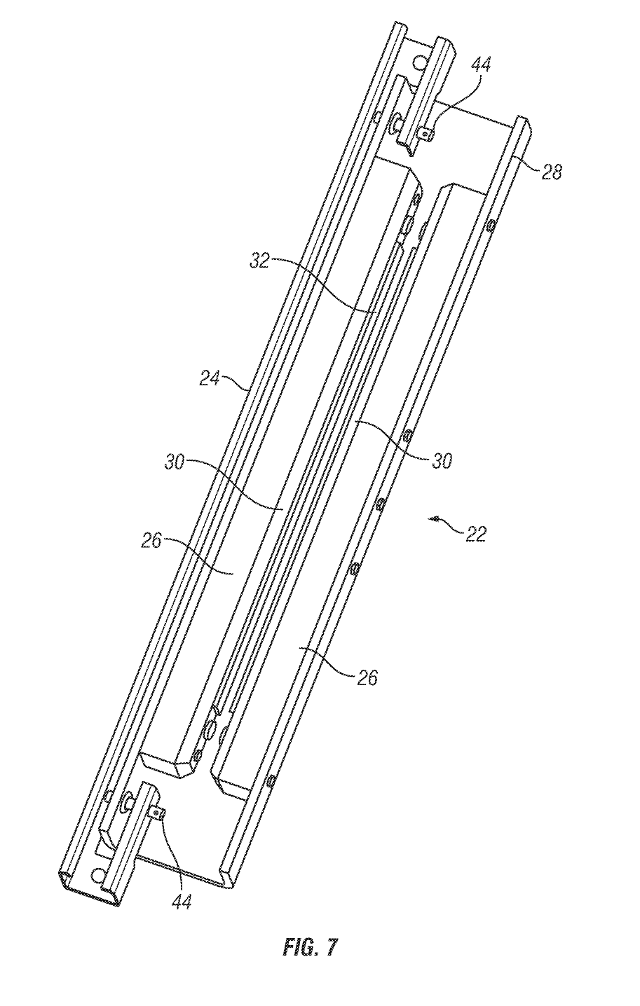

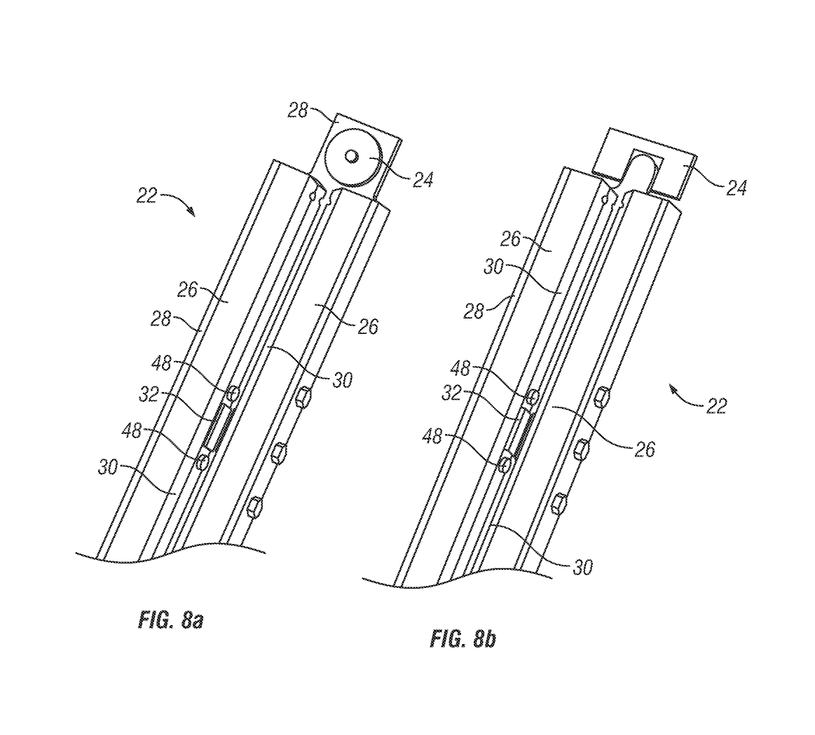

FIGS. 5-8 illustrate exemplary alternative mounting schemes for the braking system 22. In FIG. 5, the brake bracket 28 includes a bracket tab 46, with the mounting pin 44 extending through the bracket tab 46 into the support 24. FIG. 6 illustrates an embodiment where the supports 24 are connected to the braking system 22 at a flange 50 of the brake bracket 28. FIG. 7 illustrates an embodiment where a single support 24 extending the length of the braking system 22 is utilized. In the embodiment of FIG. 8, the supports 24 are formed from a compliant material such as an elastomer. The compliant material allows the side to side movement of the braking system 22.

Referring again to FIG. 2, the braking system 22 includes one or more brake guides 48. The brake guides 48 are formed from a low friction material and are located at each side of the rail 20 and extend toward the rail 20 such that when the brake pads 32 are in a retracted position, the brake guides 48 contact the rail 20 before the brake pads 32 and are utilized to maintain a selected distance between the brake pads 32 and the rail 20 when the braking system 22 is not activated. The brake guides 48 are fixed relative to the braking system 22 to urge the side to side movement of the braking system 22 when variation in the rail 20 position is encountered. When activated, the braking plate 30 and brake pads 32 move relative to the backing blocks 26 and guides 48 and move towards the rail 20. As shown in FIG. 2, the brake guides 48 may be fixed to the backing blocks 26, or alternatively may be integral to the backing blocks 26. Use of the brake guides 48 allows the brake pads 32 to be positioned closer to the rail 20 when the brake pads 32 are in a retracted position. Maintaining a selected distance between the braking surfaces and the rail 20 permits the braking system to reduce the required travel of the braking plate 30 to engage the rail 20. Reducing the clearance between the rail 20 and the brake pads 32 reduces the force necessary to retract the brake pads 32 and thereby the size of the actuator, such as the coils 42, required for this function.

Alternatively the guides 48 could be rollers on one or both sides of the rail 20. If the guides 48 were only located on one side of the rail 20, the braking system 22 would be biased in such a way—by a spring or other such device—that the guides 48 would normally be in contact with the rail 20 when the braking system 22 is not activated.

Further, as shown in FIG. 8, the brake guides 48 may alternatively extend through the braking plate 30 through a guide opening in the braking plate 30, with the braking plate 30 moving past the brake guides 48 during actuation of the brake assembly 22.

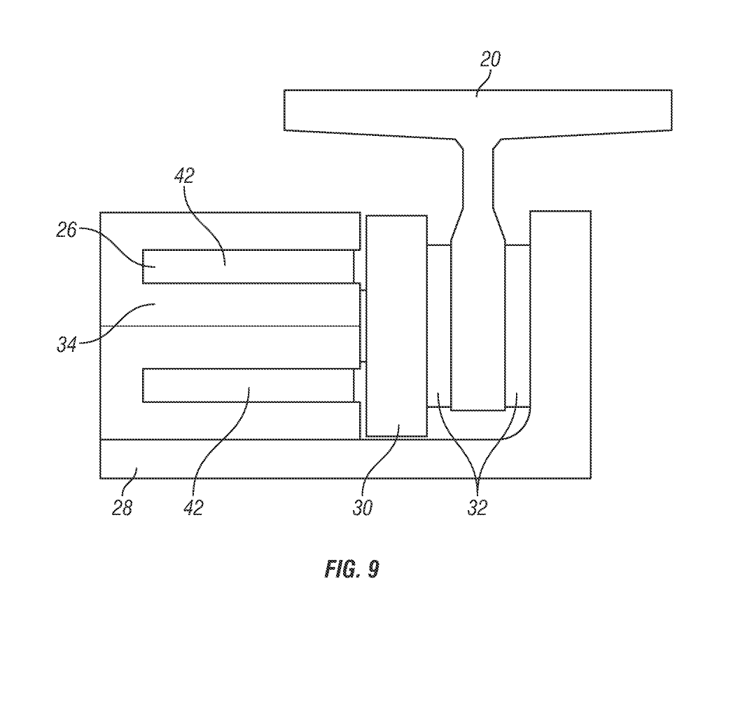

Referring now to FIG. 9, in addition to the dual-sided braking systems 22 described above, the braking system 22 may be single-sided, with a fixed brake pad 32 at a first side of the rail 20 and a movable braking plate 30 and brake pad 32 located at a second side of the rail 20. When the electrical coils 42 are deenergized, the movable braking plate 30 and brake pad 32 is urged into contact with the rail 20 and further draws the fixed brake pad 32 into contact with the rail 20.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A braking system for an elevator system comprising:
two or more braking surfaces disposed at an elevator car and frictionally engageable with a rail of an elevator system;
one or more actuators disposed at the elevator car operably connected to at least one braking surface of the two or more braking surfaces and configured to urge engagement and/or disengagement of the at least one braking surface with the rail to stop and/or hold the elevator car during operation of the elevator system; and
one or more braking guides disposed at the elevator car to maintain a selected distance between the two or more braking surfaces and the rail.

2. The braking system of claim 1, wherein the one or more actuators comprise one or more electrical coils magnetically interactive with the at least one braking surfaces.

3. The braking system of claim 2, wherein the one or more electrical coils are configured to urge the at least one braking surface away from the rail when energized.

4. The braking system of claim 1, including at least one biasing member to bias the at least one braking surface toward the rail.

5. The braking system of claim 4, wherein the at least one biasing member comprises a stack of disc springs.

6. The braking system of claim 1, further comprising at least one support to connect the braking system to the elevator car.

7. The braking system of claim 6, wherein the braking system is slidably connected to the at least one support.

8. The braking system of claim 6, wherein the at least one support is at least partially formed of a compliant material.

9. An elevator system comprising:
one or more rails fixed in a hoistway;
an elevator car configured to move through the hoistway along the one or more rails;
one or more braking systems secured to the elevator car including:
two or more braking surfaces frictionally engageable with the one or more rails;
one or more actuators operably connected to at least one braking surface of the two or more braking surfaces and configured to urge engagement and/or disengagement of the at least one braking surface with the rail to stop and/or hold the elevator car during operation of the elevator system; and
one or more braking guides disposed at the elevator car to maintain a selected distance between the two or more braking surfaces and the rail.

10. The elevator system of claim 9, wherein the one or more actuators comprise one or more electrical coils magnetically interactive with the at least one braking surfaces.

11. The elevator system of claim 10, wherein the one or more electrical coils are configured to urge the at least one braking surface away from the rail when energized.

12. The elevator system of claim 9, including at least one biasing member to bias the at least one braking surface toward the rail.

13. The elevator system of claim 12, wherein the at least one biasing member comprises a stack of disc springs.

14. The elevator system of claim 9, further comprising at least one support to connect the braking system to the elevator car.

15. The elevator system of claim 14, wherein the braking system is slidably connected to the at least one support.

16. The elevator system of claim 14, wherein the at least one support is at least partially formed of a compliant material.

17. The elevator system of claim 9, wherein the one or more braking systems is four braking systems.
